(19) United States
(12) Patent Application Publication
(10) Pub. No.: US 2009/0083981 A1
(43) Pub. Date: Apr. 2, 2009

(54) METHOD OF MANUFACTURING A MOUTHPIECE FOR A WOODWIND INSTRUMENT AND THE LIKE

(76) Inventor: Allen Theodore Wanne, Bellingham, WA (US)

Correspondence Address: GOTTLIEB RACKMAN & REISMAN PC, 270 MADISON AVENUE, 8TH FLOOR, NEW YORK, NY, 10016-0601, US

(21) Appl. No.: 11/862,239

(22) Filed: Sep. 27, 2007

(51) Int. Cl. B29D 23/00; G10D 9/02

(52) U.S. Cl. 29/896.22; 84/383 R

(57) ABSTRACT

A method of manufacturing a saxophone mouthpiece that has a complex interior chamber with tolerances of 0.005″. The present invention aims to make a mouthpiece in two parts via CNC machining, solder them together, and further CNC machine the mouthpiece. The mouthpiece is machined to have complex inner shapes that have tolerances of 0.002″ and 0.005″ over all other surfaces.

### RELATED APPLICATIONS

NONE.

### BACKGROUND OF THE INVENTION

1. Field of the Invention

The present invention relates to a method for manufacturing a saxophone mouthpiece and more particularly to an automated process for making the mouthpiece is with a complex interior chamber. The mouthpiece is made in two separate parts defining the interior chamber, and then soldered together and finally the outer surface is formed. The solder lines can extend parallel to the longitudinal axis or the tranversal axis of the mouthpiece.

2. Description of the Prior Art

A typical mouthpiece for saxophones and similar wind instruments can be considered to be a tube, with an internal hollow center or chamber. Since the 1930's, saxophone mouthpieces have been made in two parts with a left/right split (e.g. a split along a longitudinal axis of the tube). Each half is made using an investment casting process and then soldered together. To the inventor's knowledge no mouthpieces have been made of two parts split along a transversal axis.

Current manufactured mouthpieces have problems. More specifically, while they can be used to generate outer surfaces with 0.005″ accuracy over the exterior of the mouthpiece, the interior complex chambers are manufactured only with a tolerance close to 0.020″ at best. This tolerance is four times less accurate then the outer surface tolerance. The internal dimensions of a mouthpiece control the shape of the mouthpiece and, as a result, its acoustic performance. Therefore, the tolerance provided by existing manufacturing processes is often not sufficient to insure that the various mouthpieces produced maintain the intended acoustic performance, or have the same characteristics from one to the next in a production run. Hence it is the interior dimensions that require the most stringent accuracy.

### SUMMARY OF THE INVENTION

In view of the above there is a need for a manufacturing process of mouthpieces for woodwinds that resolves the problems described above. The present invention generally involves an improved process for manufacturing mouthpieces for creating a complex interior chamber. The present invention aims to manufacture a mouthpiece from two parts, solder them together, and further machine the outer surfaces. Preferably interior and exterior surfaces are formed using computer numerical control (CNC) machining techniques. The mouthpiece is machined to have complex inner shapes that have tolerances of 0.002″ and 0.005″ over all other surfaces. As a result of the achieved accuracy, mouthpieces can be created that have very complex, yet highly accurate interior shapes for improving their characteristics. The process can be performed repeatedly and reliably thereby insuring that all the mouthpieces have substantially identical dimensions.

### BRIEF DESCRIPTION OF THE FIGURES

To further satisfy the recited objectives, a detailed description of typical embodiments of the invention is provided with reference to appended drawings that are not intended to limit the scope of the invention, in which:

FIG. 1 shows two billets used to make the two halves of a mouthpiece constructed in accordance with this invention;

FIG. 1A shows a flow chart for the subject method;

FIG. 2A shows an isometric view of a left intermediate piece;

FIG. 2B shows an isometric view of a right intermediate piece;

FIG. 2C shows an end view of the right intermediate piece of FIG. 2C;

### DESCRIPTION OF THE INVENTION

The present invention may be embodied in several forms without departing from its spirit or essential characteristics. The described embodiments are to be considered in all respects only as illustrative and not as restrictive. The scope of the invention is, therefore, indicated by the appended claims and their combination in whole or in part rather than by this description. All changes that come within the meaning and range of equivalency of the claims are to be embraced within their scope.

The present invention is a method for manufacturing a mouthpiece for a musical instrument, such as a woodwind. The mouthpiece is assembled from two halves or parts. The two-part process allows interior complex shapes that are not reproducible through CNC (computer numerical control) machining when utilizing only a single billet block. That is because CNC machine tooling cannot reach inside the mouthpiece to create the required complex chamber. Only when two billets are provided, machined separately, and then later bonded together can mouthpieces created that have the required mouthpiece shapes.

The two parts may be formed by a left/right split along a longitudinal axis of the mouthpiece, or by a front/back split along a transversal axis. The front portion of a front/back split mouthpiece has an enlarged cavity where the rear portion of the main body of the respective instrument is inserted. This enlarged cavity allows the CNC tooling to enter to create complex shapes.

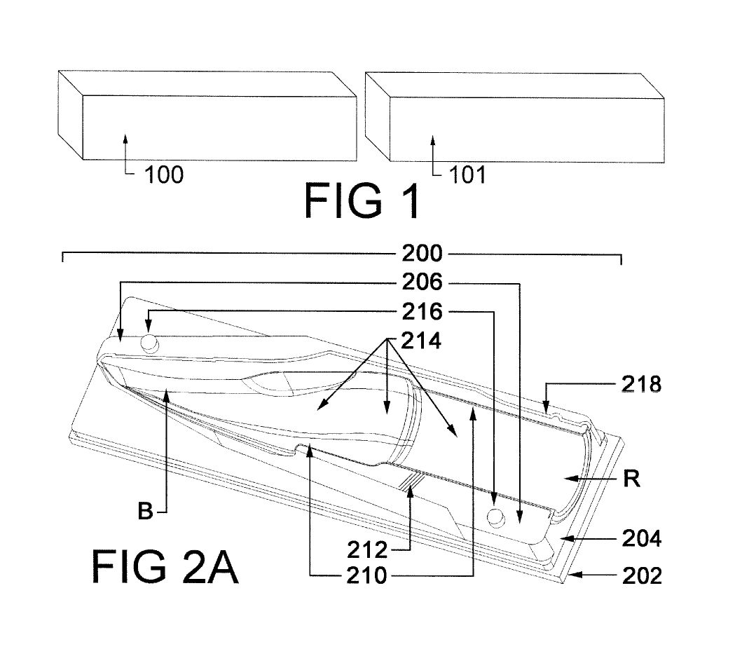

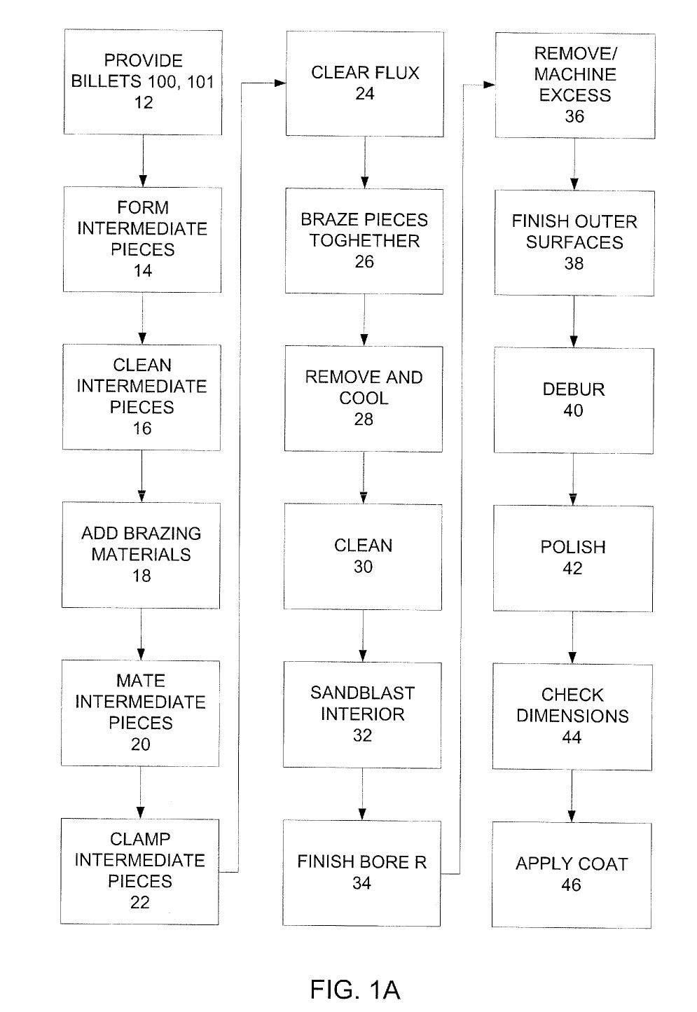

Starting with FIGS. 1 and 1A, in a preferred embodiment of the invention, two billet blocks 100, 101 are provided to make the two halves of the mouthpiece (step 10). For example, each billet can be made of a copper alloy such as C260 brass. Other materials may include any of the non-ferrous metals such as brass, bronze, titanium or aluminum. Other non-metal materials such as hard rubber, wood, etc. may be used. These materials would require being bonded with industrial glues rather than being soldered together, however, the process including all joinery and clamping of the two halves would be otherwise identical.

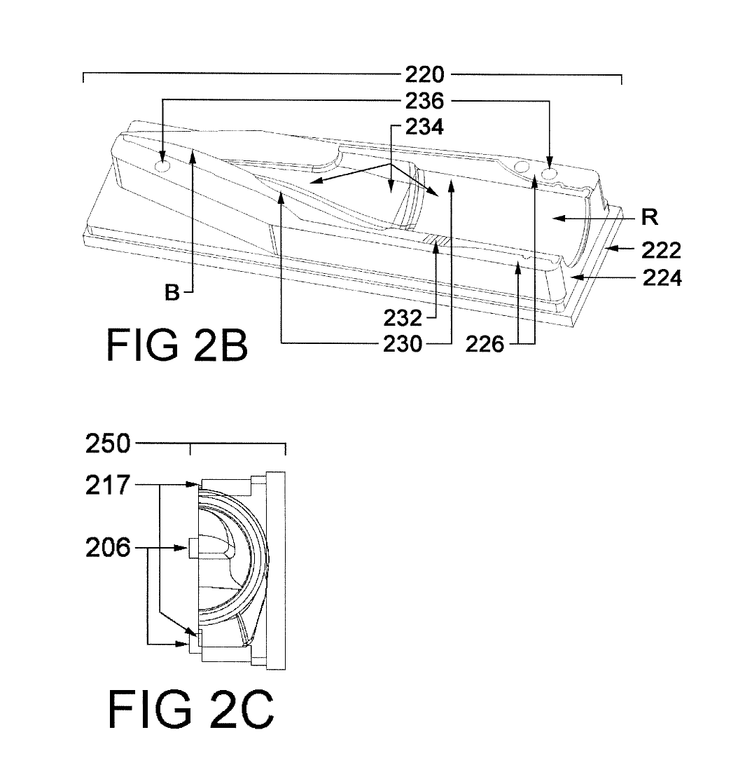

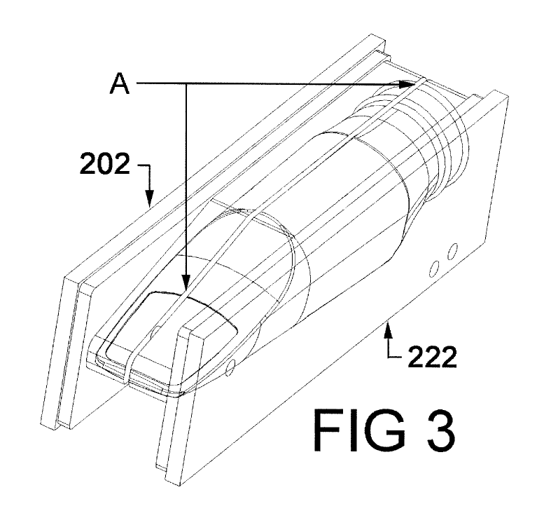

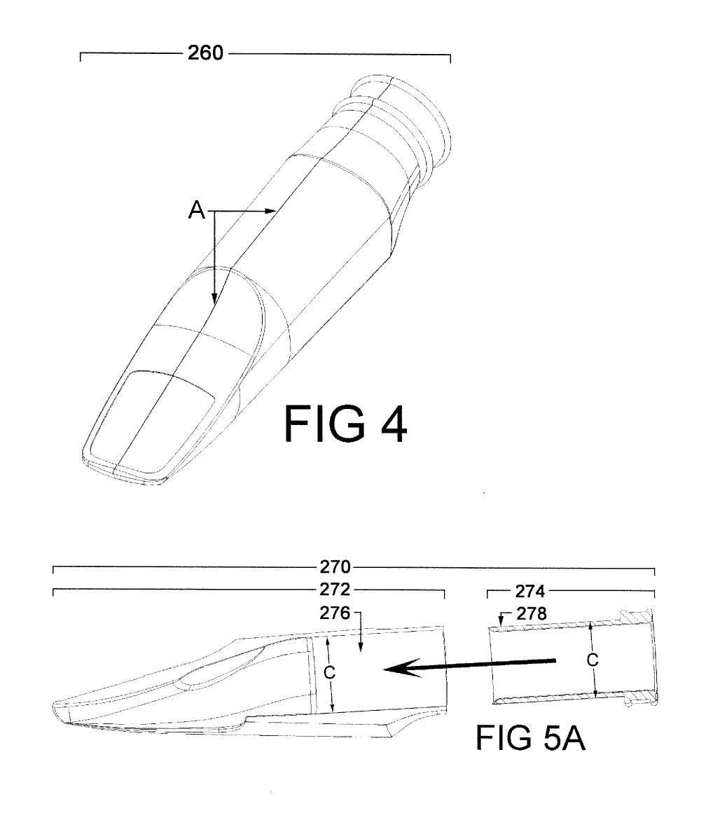

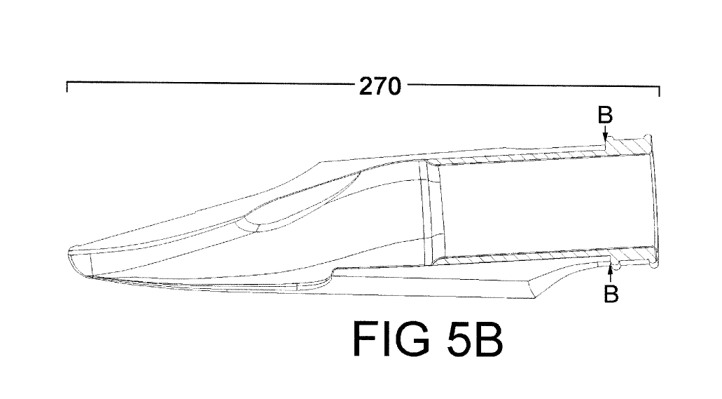

Next, first left and right intermediate pieces 200, 220 are made, as shown in FIGS. 2A and 28. Left intermediate piece 200 includes a base 202, a portion 204 having a shape which roughly follows the outline of the final product, i.e., the mouthpiece. The portion 204 rises above base 202 creating platforms 206 with a peripheral area 210. The platforms 206 can be flat, or can be formed with a plurality of microscopic ridges, as at 212. The peripheral area 210 surrounds a finely and precisely shaped depression 214 that forms half the interior opening of the mouthpiece. Posts or other extrusions 216 or openings may be formed on platforms 206.

The right intermediate piece 220 also includes a base 222, a portion 224 with platforms 226, a peripheral wall 230, optional ridges 232, and a depression 234, all similar to the corresponding elements of left intermediate piece 200. On platform 226 there are provided openings 236 or other features that mate with the elements formed on platform 206.

The two intermediate pieces 200, 220 are formed from the two billet blocks 100, 101 using a standard CNC machining system. Preferably, interior portions or depressions 214, 234 are individually machined on a fourth-axis Mori-Seiki® Duracenter 5 with tolerances within +/−0.002″, though a third or fifth axis CNC machine may also be used. The baffle B, portion nearest the lip, and the bore R, the portion where the mouthpiece attaches to the saxophone, are roughed. All other regions within the depressions 214, 234 are machined with tolerances within +/−0.005″.

The mating elements on platforms 206, 226 (e.g., posts 216 and openings 236) and ridges 212, 232 are formed or cut with a precision of 0.002″. These mating elements form male and female counterparts on the two intermediate pieces in a manner that insures that the two pieces can be mated to guarantee a perfect alignment of the depressions.

Next, the pieces 200, 220 are individually cleaned in denatured alcohol to remove any grease or oils (step 16).

In step 18 silver-soldering high temperature brazing flux is carefully applied to the mating surfaces, e.g. surfaces 206, 226. Of course other brazing material may be used, dependant on the composition of the billets 100, 101. In addition, cut strips of 45% silver brazing filler metal are placed along one of the mating surfaces, e.g., the mating surface 210 on the left intermediate piece. In steps 20. 22, the two intermediate pieces are mated together (FIG. 3). Steel fixtures clamp down upon plates 202 and 222 holding the intermediate pieces together during the brazing process. As part of this step, the male and female mating elements (including posts 216, openings 236, and/or ridges 212, 232) are joined together, to insure that the depressions 214, 234 fit together seamlessly to form the appropriate cavities. In an alternate embodiment, instead or in addition to the mating elements described above, a peripheral groove 217 (FIG. 2C) is formed in surface 210 and a matching peripheral rib 218 (FIG. 2A) is formed on surface 230 that mate together to align pieces 200, 220. The mating between the two pieces is seen in FIG. 2C.

Excess flux is cleaned (step 24) and the entire assembly is placed into a Kerr Model 666 brazing furnace with a Watlow® temperature controller where the two parts are brazed together at a temperature of 1600 degrees F. for 9.5 minutes (step 26). The assembly is then removed and cooled (step 28) until it is no longer incandescent. In another embodiment the parts will be bonded together through differing means, depending on the material used, including but not limited to soldering, welding and industrial glues.

A seam is formed in the resulting intermediate piece along a brazing plane A for a left/right split (FIG. 4). In an alternate embodiment, front/back intermediate pieces are formed along a transversal plane that is perpendicular to the longitudinal axis of the final mouthpiece. For this embodiment, a seam is formed along a plane for a front/back split (FIG. 5B).

The assembly of FIG. 3 is put into a caustic cleaning agent solution (colloquially known as pickle) to remove any oxidation and scaling left by the brazing process (step 30). The interior chamber of the mouthpiece is sandblasted with 80 grit aluminum oxide media at a pressure of 30 PSI to create a more uniform, homogenous surface (step 32). The interior chamber is now accurately formed within +/−0.005″. This type of accuracy has never before been accomplished in the saxophone industry on a large chambered mouthpiece interior.

The mouthpiece is then placed back into the mill that the left and right intermediate pieces were machined in. The bore R is finish machined to tolerances of +/−0.005″. (step 34) and most of the excess material used to clamp the two parts together is roughed away in the three precision work-holding operations (step 34) to form a rough mouthpiece.

The rough mouthpiece is then placed in a Mori-Seiki® Duracenter 5 milling center with a Haas® 4^{th} axis indexer (model # SHA5CB). The mouthpiece bore R is placed over an expanding collet (not shown). The mouthpiece is rotationally located on the 4^{th} axis indexer, parallel to the table of the mill. This allows the mouthpiece to rotate any angle for complex machining. The expanding collet is opened, securely holding the mouthpiece in place. All outside surfaces are finish machined. The inside surfaces accessible from the window W, the opening under the reed (i.e., bore B in FIG. 2B) into the mouthpiece, the table and facing curve are finish machined within tolerances of +/−0.002″ (step 38). Remaining burrs are removed by hand (step 40). The resultant finished mouthpiece 260 (FIG. 4) is a single piece with a perfect and accurately reproducible interior and exterior.

A digital inspection is used process verifies all critical dimensions. This inspection is performed with Mitutoyo® digital calipers, a digital micrometer, a digital height gauge, class Z gauge pins, custom-made engraved glass scale, proprietary thickness gauge set, Mitutoyo® PH-3500 optical comparator and other equipment as needed (step 44).

The mouthpiece is loaded onto a custom-made Delrin® acetal and nylon fixture with other identical mouthpieces. The mouthpiece is then polished with a rotary tumble polishing process. The mouthpiece is once more inspected. A protection plating of 14 kt gold, 18 kt gold, silver or other suitable material is applied (step 46). The mouthpiece is assembled with other accessory components. The completed mouthpiece with accessory components is placed in its retail packaging for sale.

As described above, final mouthpiece 260 is formed with a seam along longitudinal plane A (in the finished mouthpiece, the seam may be invisible) as shown in FIG. 4.

In an alternate embodiment, shown in FIGS. 5A and 5B, a mouthpiece 270 is made by the process described above, wherein the mouthpiece is formed of a front intermediate piece 272 and a back intermediate piece 274. The front intermediate piece is formed with a tubular opening 276 having an inner-diameter C. The back-piece 274 is formed with a front cylindrical section 278 whose exterior diameter is identical to C and therefore fits telescopically into the opening 276. The two pieces are fit together and then they are brazed along transversal plane B.

Although the invention has been described with reference to particular embodiments, it is to be understood that these embodiments are merely illustrative of the application of the principles of the invention. Numerous modifications may be made therein and other arrangements may be devised without departing from the spirit and scope of the invention.

What is claimed is:

1. A method of manufacturing a mouthpiece for wind instrument comprising:
machining two billet blocks using a CNC system to create two intermediate pieces having respective mating surfaces;
joining the intermediate pieces together along said mating surfaces to form a rough mouthpiece; and
machining the blocks using a computer numerical control process to create the exterior shape.

2. The method of claim 1 wherein said mouthpiece has a longitudinal axis and said mating surfaces define a plane for said bonding, said plane being parallel to said longitudinal axis.

3. The method of claim 2 wherein said intermediate pieces are disposed to the right and left of said plane, respectively.

4. The method of claim 1 wherein said mouthpiece has a longitudinal axis and said mating surfaces define a plane for said bonding, said plane being transversal to said longitudinal axis.

5. The method of claim 4 wherein said plane is perpendicular to said longitudinal axis.

6. The method of claim 1 wherein said two intermediate pieces are joined using one of a bonding and soldering process.

7. A method of manufacturing a mouthpiece comprising:
providing two billet blocks, each billet block having a flat surface;
machining the two billet blocks to create in each block a respective depression using a CDC machining system, said depressions being mirror images of each other to form a right and a left intermediate piece, said flat surfaces around said depressions forming bonding surfaces;
bonding the billet blocks together along the lengths of the interior chambers to form a rough mouthpiece; and
machining at least portions of the outer surfaces of the rough mouthpiece to form the finished mouthpiece.

8. The method of claim 7 wherein portions of the outer surfaces of the finished mouthpiece are formed during the step of machining the two billet blocks.

9. The method of claim 7 wherein said right and left intermediate pieces are formed with matting elements, said matting elements being joined together prior to bonding to align edges of the respective openings.

10. The method of claim 9 wherein said intermediate pieces are formed with matting surfaces, said matting elements being formed on said matting elements are formed on said bonding surfaces.

11. The method of claim 10 wherein said intermediate pieces have ridges formed on said bonding surfaces for aligning said depressions.

12. A method of manufacturing a mouthpiece comprising:
machining two metallic blocks to create two intermediate pieces with mirror-image depressions and matting elements, said machining being performed using CNC machining system;
cleaning the intermediate pieces
applying a brazing material to edges of said depressions;
clamping the intermediate pieces with the matting elements being joined to align said depressions to form an interior opening of preselected shape and size;
brazing the intermediate pieces together at a elevated temperature for a predetermined period of time to create a rough piece with a seam;
allowing the rough piece to cool;
sandblasting the interior opening to finish its interior surface; and
machining the rough piece to form an exterior surface thereon.

13. The method of claim 12 wherein the metallic blocks are billet blocks made of unleaded brass.

14. The method of claim 13 wherein the brazing of the two blocks together is performed at a temperature of approximately 1600 degrees F. and for a period of approximately 9.5 minutes.

15. The method of claim 14 wherein the sheet solder is silver-soldering temperature brazing flux.
